(19) United States
(12) Patent Application Publication
(10) Pub. No.: US 2007/0142587 A1
(43) Pub. Date: Jun. 21, 2007

(54) Composites of poly (tert-butylacrylate) and process for the preparation thereof

(75) Inventors: Gregory L. Baker, Haslett, MI (US); Zhiyi Bao, Lansing, MI (US); Merlin L. Bruening, East Lansing, MI (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 11/639,171

(22) Filed: Dec. 14, 2006

Related U.S. Application Data
(60) Provisional application No. 60/751,622, filed on Dec. 19, 2005.

(51) Int. Cl. C08F 226/02

(52) U.S. Cl. 526/301

(57) ABSTRACT

A composite of poly(tert-butylacrylate) linked by a linker moiety to a substrate is described. The composites are useful for binding reactive molecules to terminal acid groups of the polymer to thereby anchor chemical reagents such as proteins and biomolecules.

### CROSS-REFERENCE TO RELATED APPLICATIONS

This application claims benefit to Provisional Application Ser. No. 60/751,622, filed Dec. 19, 2005, which is incorporated herein by reference in its entirety.

### STATEMENT REGARDING FEDERALLY SPONSORED RESEARCH OR DEVELOPMENT

Not Applicable

### STATEMENT REGARDING GOVERNMENT RIGHTS

Not Applicable

### BACKGROUND OF THE INVENTION

(1) Field of the Invention

The present invention relates to composites of poly(tert-butylacrylate) linked by a linker moiety to a substrate. The present invention also relates to a process for the preparation of the composites.

(2) Description of the Related Art

Immobilization of polyacrylic acid (PAA) is one of the most convenient and effective strategies for the chemical functionalization of surfaces. The pendent carboxylic acids of PAA can chelate metals, induce changes in surface properties as a function of pH, and serve as scaffolds for anchoring chemical reagents, proteins, and other biomolecules. An early approach to create PAA-decorated surfaces employed grafting of hyperbranched PAA to substrates (Crooks, R. M., Chemphyschem 2 (11) 644-654 (2001)). While this graft-on-graft process is inherently slow, this technique provides relatively thick films for anchoring chemical reagents and biomolecules. Compared to “grafting to” strategies, direct growth of polymers from surfaces provides polymer brushes with greater chain densities. For instance, 400 nm poly(methacrylic acid) films were synthesized in 6 hours by free-radical polymerization of methacrylic acid initiated from surface anchored azo initiators (Konradi, R., et al., Macromolecules 37 (18) 6954-6961 (2004)). Growth of polymers from surfaces using Atom Transfer Radical Polymerization (ATRP) (Matyjaszewski, K., et al., Chemical Reviews 101 (9) 2921-2990) (2001); and Kamigaito, M., et al., Chemical Reviews 101 (12) 3689-3745 (2001)) and other controlled polymerization methods has become a powerful strategy for anchoring well-defined polymers to substrates, but using ATRP to grow PAA from surfaces is problematic since carboxylic acids react with the copper-amine catalysts typically used for ATRP. A partial solution is to polymerize tert-butyl acrylate (tBA) from a surface, and then hydrolyze PtBA to PAA. While widely used for preparing block copolymers containing a PAA block (Ma, Q. G., et al., Journal Of Polymer Science Part A-Polymer Chemistry 38 4805-4820 (2000); and Boyes, S. G., et al., Macromolecules 36 (25) 9539-9548 (2003)), application of this approach to surface-initiated polymerization is limited by slow polymerization rates (<5 nm/hr) and thin film thickness (<20 nm) (Boyes, S. G., et al., Macromolecules 36 (25) 9539-9548 (2003); Matyjaszewski, K., et al., Macromolecules 32 (26) 8716-8724 (1999); Shah, R. R., et al., Macromolecules 33 (2) 597-605(2000); Kong, H., et al., Journal of Materials Chemistry 14 (9) 1401-1405 (2004); and Yan, X. H., et al., Macromolecules 34 (26) 9112 (2001)). Other controlled polymerization schemes such as RAFT (Chiefari, J., et al., Macromolecules 31 (16) 5559 (1998)) and nitroxide-mediated polymerizations (Couvreur, L., et al., Macromolecules 36 (22) 8260-8267 (2003); and Grande, D., et al., Journal of Polymer Science Part A-Polymer Chemistry 43 (3) 519-533 (2005)), are insensitive to carboxylic acids and could be capable of polymerizing acrylic acid, but polymerization rates will likely also be low. Poly(tert-butyl acrylate) brushes were prepared by Yao et al (J. Am. Chem. Soc. 125 16015-16024 (2003)), and Li et al (J. Am. Chem. Soc. 127 6248-6256 (2005)). These references show the use of aromatic rings in the linker groups.

### OBJECTS

It is therefore an object of the present invention to provide a poly(tert-butylacrylate) linked to a substrate to provide a composite. It is also an object of the present invention to provide a process for the preparation of the composites. It is also an object of the present invention to provide an economical and efficient process for the preparation of the composites. These and other objects will become increasingly apparent by reference to the following description.

### SUMMARY OF THE INVENTION

The present invention relates to a composite which comprises:

(a) a substrate with an exposed surface;

(b) a linker moiety linked at a proximal end to the exposed surface on the substrate and linked at a distal end through a polymer to a halogenated initiator moiety; and

(c) a poly(tert-butylacrylate) polymer as the polymer linked to the initiator moiety and optionally with a distal acrylic acid moiety in place of a tert-butylacrylate moiety. Preferably the exposed surface of the substrate is a precious metal selected from the group consisting of Au, Pt, Al, SiO₂, Si and organic polymers. Preferably the linker moiety and the polymer together have a thickness between about 100 nm and 350 nm on the exposed surface of the substrate. Preferably the linker moiety comprises (CH₂), wherein n is 2 to 20. Preferably the linker moiety comprises (CH₂)ₙ wherein n is 11. Preferably the substrate is a precious metal. Preferably the linker moiety is comprised of sulfur which is linked to the exposed surface and the sulfur is linked to a (CH₂)ₙ moiety, wherein n is 2 to 20. Preferably the linker moiety is comprised of sulfur which is linked to the substrate and the sulfur is linked to a (CH₂)ₙ moiety and wherein the initiator is a 2-halo propionyl halide moiety linked to a terminal of the (CH₂)ₙ moiety, where halo and halide are bromine or chlorine.

The present invention also relates to a process for the preparation of a composite which comprises:

(a) providing a substrate linked by a linker moiety on an exposed substrate linked to a halogenated initiator moiety;

(b) introducing a vinyl monomer with the linker moiety on the substrate along with a reduced transition metal linked to a ligand as a catalyst to provide a reaction mixture; and

(c) heating the reaction mixture to polymerize the vinyl monomer from the initiator with displacement of a halogen from the initiator to provide the polymer linked to the linker moiety which is linked to the substrate. Preferably a non-reactive solvent is provided in step (a). Preferably the exposed surface of the substrate is selected from the group consisting of Au, Pt, Al, SiO₂, Si and organic polymers. Preferably the linker moiety and the polymer together have a thickness between about 100 nm and 350 nm on the surface of the substrate. Preferably the linker moiety is comprised of sulfur linked to the exposed surface and the sulfur linked to (CH₂)ₙ linked to the initiator moiety, wherein n is 2 to 20. Preferably the linker moiety is comprised of sulfur linked to the surface and the sulfur is linked to (CH₂)₁₁ linked to the initiator moiety which is a 2-halo propionyl halide moiety linked to a terminal of the (CH₂)₁₁, where halo and halide are chlorine or bromine. Preferably the initiator moiety is comprised of a 2-bromo propionyl bromide moiety. Preferably the heating is at a temperature between about 25 and 55° C. Preferably the halogen is bromide. Preferably wherein the vinyl monomer is tert-butylacrylate (tBA). Preferably wherein the solvent is a mixture of dimethylformamide (DMF) and anisole. Preferably in addition a terminal tert-butyl moiety of the acrylate has been hydrolyzed to the acrylic acid moiety. Preferably in addition a terminal tert-butyl moiety of the acrylate is hydrolyzed to the acrylic acid moiety. Further, wherein the vinyl monomer is selected from the group consisting of 4-vinyl pyridine, styrene methyl methacrylate, 2-hydroxyl ethyl methacrylate, and an alkyl acrylic monomer. Finally, wherein the vinyl monomer is selected from the group consisting of 4-vinyl pyridine, styrene, and methyl methacrylate.

The term “linker moiety” refers to an organic group which is preferably linear and containing 3 to 20 carbon atoms with a halogenated initiator moiety as part of the moiety.

The term “alkylene” means a linear carbon chain moiety of —CH₂— groups which does not contain aromatic groups and which can be substituted with hetero groups such as O, N and S and halogen groups such as I, F, Cl and Br.

The substance and advantages of the present invention will become increasingly apparent by reference to the following drawings and the description.

### BRIEF DESCRIPTION OF FIGURES

FIG. 1 is a graph showing reflectance FTIR spectra of gold substrates with (a) an immobilized initiator layer; (b) 150 nm PtBA polymer brushes grown from the initiator layer; (c) 60 nm PAA brushes prepared by a 10-min hydrolysis of the PtBA film in a 15 μM solution of CH₃SO₃H in CH₂Cl₂; and (d) PAA brushes after dipping in pH 10 buffer solution for 10 min.

FIG. 2 is a graph showing ellipsometric thicknesses of polymer brushes vs. polymerization time in ATRP of tert-butylacrylate (tBA), methyl methacrylate (MMA), styrene and 4-vinyl pyridine (4-VP) from initiator-coated Au substrate at 50° C.

FIG. 3 is an ellipsometric thickness of polymer brushes vs. polymerization time in ATRP of tert-butylacrylate (tBA), methyl methacrylate (MMA), styrene and 4-vinyl pyridine (4-VP) from a silicon substrate at 50° C.

The term “substrate” means any material metallic inorganic or organic which has a surface allowing linking of the initiator moiety. Examples are noble metals, ceramics and polymers with active surfaces allowing linking. Any number of reactive moieties can be used to form the link to the substrate.

Typically the polymerization is conducted in an oxygen-free solution of a non-reactive solvent and a metal ligand which performs as a catalyst. A cuprous halide ligand is preferred. The metals are preferably Cu, Fe, Ru, Rh, Ni and Re. The ligands are multi-dentate chelating amines. The preferred amines are shown in the Examples and are tetramethylcyclam and 1,4,7-trimethyl-1,4,7-tri azacycloamine.

### DESCRIPTION OF THE PREFERRED EMBODIMENTS

The present invention thus relates to the rapid polymerization of tert-butyl acrylate (tBA) from surfaces under mild conditions (50° C.) using surface-initiated Atom Transfer Radical Polymerization (ATRP). The polymerization rate is remarkably high, yielding 100 nm thick poly(tert-butyl acrylate) (PtBA) brushes on flat Au surfaces in just 5 minutes. Rapid growth of thick PtBA films has important technological implications since PtBA brushes are readily hydrolyzed to hydrophilic PAA films. The chemical versatility of PAA and the ability to obtain >200 nm films in a fraction of an hour suggest that this approach could be adapted for practical frunctionalization of large area surfaces.

The ATRP process described here provides a uniquely rapid method for forming 100 nm-thick PAA brushes. The initial work focused on the growth of tBA from reflective Au surfaces because of the ease of characterizing the resulting polymer films by reflectance IR spectroscopy and ellipsometry, and the ability to cleave polymer brushes from Au to measure their molecular weight distribution by Gel Permeation Chromatography (GPC). Similar results can occur for tBA polymerization from any surface on which initiators can be immobilized, including metals, silica, metal oxides, and polymers. Scheme 1 shows the synthetic route to high molecular weight polyacrylic acid films. Formation of a mercaptoundecanol self-assembled monolayer on an Au-coated silicon wafer followed by reaction with 2-bromopropionyl bromide yielded a dense initiator monolayer (Kim, J. B., et al., Journal of the American Chemical Society 122 (31) 7616-7617 (2000)). Immersion of the initiator-coated substrate in a mixture of monomer, Cu(I)1,4,8,11-tetramethyl-1,4,8,11-tetraazacyclotetradecane (Me₄Cyclam), and Cu(II)dnNbpy₂ dissolved in a 1:1 mixture of DMF and anisole initiated rapid polymerization of tBA at 50° C. At predetermined times, the substrates were removed from the solution and after washing with solvent to remove residual catalyst and monomer and drying with N₂, the films were characterized by FTIR spectroscopy and ellipsometry.

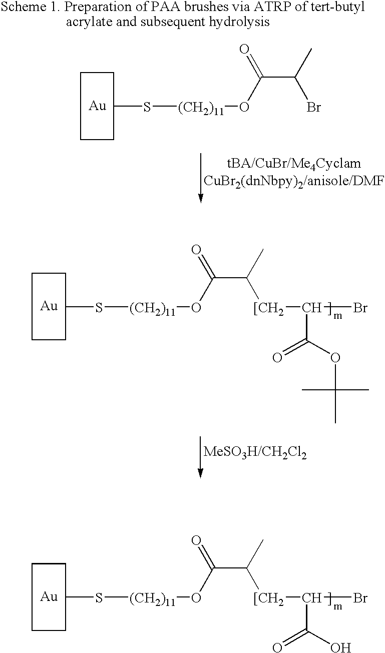

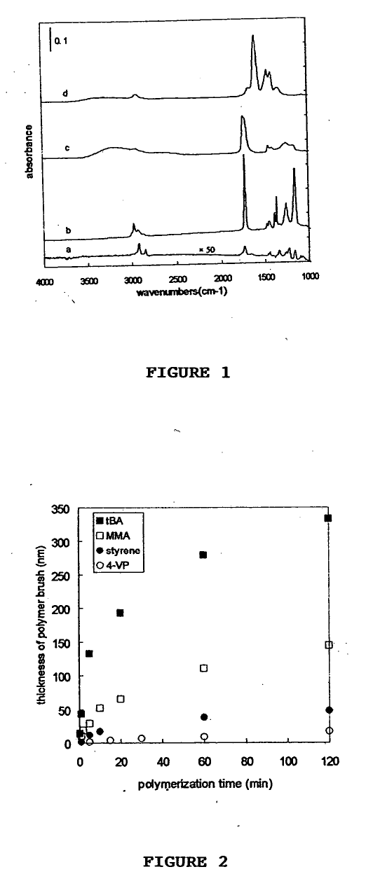

Growth of PtBA brushes was apparent from the appearance of a carbonyl peak at 1740 cm⁻¹ and tert-butyl ester peaks at 1390 cm⁻¹ and 1180 cm⁻¹ in the reflectance FTIR spectrum of the film (FIG. 1B). The film thickness measured by ellipsometry was ˜100 nm for a 5 minute polymerization. Hydrolysis of a 150 nm thick film of PtBA using 15 μM methanesulfonic acid in CH₂Cl₂ for 10 min yielded a 60 nm PAA film. The formation of PAA was apparent from a broad carboxylic acid peak at 3000-3500 cm⁻¹ and disappearance of the tert-butyl ester peaks (FIG. 1C). To prove complete conversion of the tert-butyl peak to the corresponding acid, we treated the film with a pH 10 sodium diphosphate solution followed by rinsing with ethanol. The resulting FTIR spectrum showed the loss of the OH band at 3000-3500 cm⁻¹ and the complete disappearance of the carbonyl peak at 1740 cm⁻¹, as well as the growth of characteristic carboxylate peaks at 1610 cm⁻¹ and 1450 cm⁻¹ (FIG. 1D).

The high polymerization rates and thicknesses for PtBA are unusual for ATRP systems, which generally provide control over molecular weight and polydispersity by maintaining a low concentration of growing chain ends. The low concentration of radicals minimizes termination by coupling or disproportionation but also yields a low polymerization rate. The position of the equilibrium between dormant (halogen capped) chain ends and active, growing chains depends on the choice of the amine ligand for Cu(I), and the amount of Cu(II) species added to the system. FIG. 2 shows kinetic data for the surface-initiated polymerization of tBA (black squares) from initiators attached to gold substrates. A linear relationship between film thickness and time is expected for well-controlled ATRP, but the data show a rapid increase in thickness and a growth rate that decreases with time. This is indicative of a relatively high concentration of radicals that leads to both termination and a high polymerization rate. The loss of some control in this polymerization system is more than compensated by the possibility of growing films in a few minutes.

Our success with PtBA polymerization prompted us to examine other monomers to see if they too could be polymerized rapidly and provide thick films. FIG. 2 shows data for the polymerization of styrene, methyl methacrylate and vinyl pyridine. In all cases the polymerization rates were slower than for tBA, and the limiting film thicknesses were lower. However, the polymerization rate was still significantly higher than those described to date. For example, Huck et al. reported the growth of 35 nm thick PMMA films from Au in 2 hours (Jones, D. M. and Huck, W. T. S., Advanced Materials 13 (16) 1256-1259 (2001), while the Me₄Cyclam/CuBr system gave a 100 nm thick PMMA film in just 1 hour. Matyjaszewski et al grew a 6 nm thick polystyrene film in 2 h from a silicon substrate at 100° C. (Matyjaszewski, K., et al., Macromolecules 32 (26) 8716-8724 (1999), compared to a 30 nm film from Au in 1 h at 50° C. Despite the potential utility of poly(vinyl pyridine) brushes, we are unaware of any examples of the surface-initiated polymerization of 4-vinyl pyridine from Au. The kinetic data for polymerization of these monomers suggest that the unusually rapid growth of PtBA films stems from a combination of tBA's fast propagation rate and reduced bimolecular coupling due to the steric bulk of the monomer.

The Me₄Cyclam/CuBr ATRP system was previously used to polymerize dimethylacrylamide (Rademacher, J. T., et al., Macromolecules 33 (2) 284-288 (2000); and Teodorescu, M., et al., Macromolecules 32 (15) 4826-4831 (1999) and 2-vinyl-4,4-dimethyl-5-oxazolone (Fournier, D., et al., Macromolecules 37 (2) 330-335 (2004). In both cases, control over the molecular weight was marginal, most likely due to an inefficient back reaction (R·+CuX₂→CuX) and insufficient deactivation of chain ends (Pintauer, T., et al., Coordination Chemistry Reviews 249 (11-12) 1155 (2005)). We examined the solution polymerization of tBA at 50° C. to test the notion that the tBA polymerizations might best be described as redox-initiated free-radical polymerizations, where the rate of the back reaction is negligible. For these reactions, ethyl 2-bromo isobutyrate was injected into a solution of monomer and catalyst to initiate polymerization. We found that Mn was higher than would be predicted by the monomer conversion. In the 20-80% conversion interval, Mn decreased by one half while the polydispersity increased from 1.15 to 1.37. The solution polymerization data are consistent with a redox-initiated free radical polymerization.

It is important to note that while ATRP of tBA is not a “living” polymerization, the rapid growth rate, high film thicknesses and ease of converting PtBA to PAA make this an attractive protocol for preparing surfaces terminated in carboxylic acids.

### EXAMPLE 1

Preparation of Initiator-Immobilized Gold Substrates

Gold-coated Si wafers (200 nm of gold sputtered on 20 nm of Cr on Si (100) wafers) were cleaned before use. An initiator moiety (SAM) was formed on gold by immersing the gold substrate in a 1 mM ethanolic solution of MUD (HS(CH₂)₁₁OH) for 24 h. The reaction was done in a glove bag filled with N₂ to avoid contamination from water. The ellipsometric thickness of the MUD layer was 10-15 nm. The gold substrates with the MUD SAM were transferred to a dry box filled with N₂ and were dipped in a solution of 0.12 M triethylamine in anhydrous THF at ˜0° C. After 1 min, a solution of 2-bromo-propionyl bromide in anhydrous THF (0.1 M) was added dropwise onto the surface of the substrate to achieve near-quantitative initiator immobilization. The reaction time was limited to 2-3 min since thiol-terminated SAMs could be unstable in the presence of acid bromides. After rinsing with THF in the dry box, the gold substrates were removed from the dry box, rinsed with ethyl acetate, ethanol and Milli-Q water (18 MΩcm) sequentially and dried under a stream of N₂.

Surface-Initiated Polymerization from Initiator-Immobilized Gold Substrates

In a N₂-filled drybox, 5.74 mg (0.04 mmol) of CuBr, 4.47 mg (0.02 mmol) of CuBr₂, 10.26 mg (0.04 mmol) of 1,4,8,11-tetramethyl-1,4,8,11-tetraazacyclotetradecane (Me₄Cyclam), and 16.35 mg (0.04 mmol) of 4,4′-dinonyl-2,2′-dipyridyl (dnNbpy) were added to a round bottom flask containing 20 mL of a solution of tBA in DMF/anisole, (2:1:1 v:v:v). The mixture was well-stirred in a round bottom flask and heated with an oil bath to 50° C. until a transparent light green solution formed. The solution was then transferred into a small vial with one initiator-immobilized gold substrate to start the surface-initiated polymerization in a 50° C. oil bath. After a set reaction time, the substrate was removed from the vial, washed sequentially with ethyl acetate and THF and dried under a stream of N₂. The same conditions were used for polymerization of methyl methacrylate, styrene and 4-vinyl pyridine.

Solution Polymerization of Tert-Butyl Acrylate.

The polymerization followed the procedure used for surface-initiated polymerization. In a N₂-filled drybox, 5.74 mg (0.04 mmol) of CuBr, 4.47 mg (0.02 mmol) of CuBr₂, 10.26 mg (0.04 mmol) of 1,4,8,11-tetramethyl-1,4,8,11-tetraazacyclotetra decane (Me₄Cyclam), and 16.35 mg (0.04 mmol) of 4,4′-dinonyl-2,2′-Odipyridyl (dnNbpy) was well stirred in a round bottom flask at 50° C. in an oil bath until a transparent light green solution was formed. 2-bromoisobutyrate (2 mM) was syringed into the flask to initiate the solution polymerization. After a set reaction time, 2 mL of the polymerization solution was transferred into a small vial and another 2 mL DMF solution of 2 mM CuBr₂ and 4 mM dnNbpy was added quickly to quench the polymerization. The quenched solution was transferred out of the drybox for further characterization. Pure PtBA was obtained using benzene as solvent and methanol/water (9/1) mixture as precipitants.

Characterization Methods

Film thicknesses were measured using a rotating analyzer ellipsometer (model M-44; J. A. Woollam) at an incident angle of 75°. The data were analyzed using WVASE32 software. Thickness measurements were taken on at least three spots on each substrate. Reflectance FTIR spectroscopy was performed using a Nicolet Magna-IR 560 spectrometer containing a PIKE grazing angle (80°) attachment. Routine ¹H NMR spectra (500 MHz) was recorded using CDCl₃ as the solvent. Mn was measured by Gel Permeation Chromatography) (GPC) at 35° C. using two PLgel 10μ mixed-B columns in series, and a Waters R410 differential refractometer detector. Mw was measured using a DAWN EOS static light scattering instrument at 35° C., with scattering angles from 0° to 155.4° at laser wavelength of 690 nm. The dn/dc value for PtBA was measured using a pure PtBA sample and was used for all Mw determinations. Polystyrene standards were used for both GPC and SLS measurements. THF was used as the eluent at a flow rate 1 mL/min for both GPC and SLS measurements.

TABLE 1
GPC and light scattering measurements of PtBA
synthesized in solution ATRP

| Time | Convn^{a} | | | | | |
|---|---|---|---|---|---|---|
| (min) | (%) | Mn, calc^{b} × 10⁵ | Mn, GPC^{c} × 10⁵ | PDI^{c} | M_{w,SLS}^{d} × 10⁵ | PDI^{d} |
| 0.17 | 7.95 | 0.20 | 2.92 | 1.38 | 5.31 | 1.25 |
| 0.5 | 19.8 | 0.51 | 2.83 | 1.39 | 4.77 | 1.31 |
| 1 | 23.2 | 0.59 | 1.50 | 1.50 | 4.95 | 1.15 |
| 2 | 30.6 | 0.78 | 2.27 | 1.53 | 4.19 | 1.17 |
| 5 | 55.2 | 1.41 | 1.86 | 1.61 | 3.47 | 1.26 |
| 10 | 63.5 | 1.63 | 1.86 | 1.61 | 3.04 | 1.35 |
| 20 | 70.7 | 1.81 | 1.74 | 1.66 | 3.06 | 1.34 |
| 30 | 74.9 | 1.92 | 1.91 | 1.52 | 2.91 | 1.35 |
| 60 | 81.5 | 2.09 | 2.02 | 1.55 | 2.60 | 1.37 |

^{a}calculated from ¹H NMR.
^{b}obtained from ¹H NMR conversion.
^{c}calibrated against linear PS standards.
^{d}measured by static light scattering in THF, dn/dc = 0.043 was determined using a refractive index detector and was used for all PtBA samples.

### EXAMPLE 2

The following example shows the growth of poly(tert-butylacrylate) from a silicon substrate.

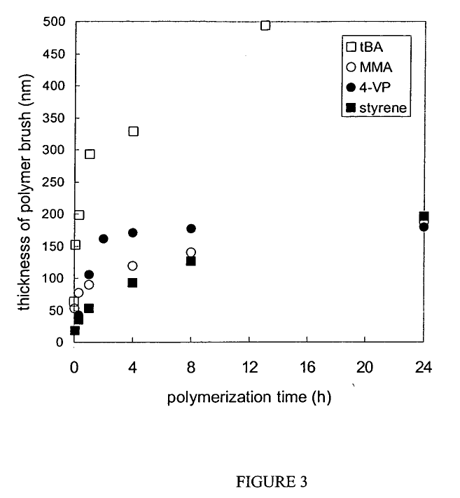

A dense initiator monolayer was formed from a silicon wafer by reaction with (11-(2-bromo-2-methyl)propionyloxy)undecyldimethylchlorosilane. In a N₂-filled drybox, the initiator-coated substrate was immersed in a mixture of tert-butyl acrylate, Cu(I)1,4,8,11-tetramethyl-1,4,8,11-tetraazacyclotetradecane (Me₄Cyclam), and Cu(II)dnNbpy₂ dissolved in 1:1 mixture of DMF and anisole at 50° C. to initiate rapid polymerization of tert-butyl acrylate. At predetermined times, the substrates were removed from the solution and after washing with solvent to remove residual catalyst and monomer, the dried films were characterized by ellipsometry. The film thickness of PtBA measured by ellipsometry was remarkable, ˜150 nm for a 5 minute polymerization. Other purified monomers such as methyl methacrylate, styrene and 4-vinyl pyridine were polymerized using the same procedure. The polymerization time vs. thickness is shown in FIG. 3.

Coating substrates with polyelectrolyte multilayers terminated with poly(acrylic acid) (PAA) and subsequent activation of the free-COOH groups of PAA provides a surface that readily reacts with amine groups to allow covalent immobilization of antibodies. The use of this procedure to prepare arrays of antibodies in porous alumina supports facilitating construction of a flow-through system for analysis of fluorescently labeled antigens. PAA-terminated films resist nonspecific protein adsorption, so blocking of antibody arrays with bovine serum albumin is not necessary. These microarrays can be capable of effective analysis in 10% fetal bovine serum.

Also, 2-hydroxymethyl methacrylate can be processed into a polymer as previously described. It is well suited to aqueous polymerization.

It is intended that the foregoing description be only illustrative of the present invention and that the present invention be limited only by the hereinafter appended claims.

We claim:

1. A composite which comprises:
(a) a substrate with an exposed surface;
(b) a linker moiety linked at a proximal end to the exposed surface on the substrate and linked at a distal end through a polymer to a halogenated initiator moiety; and
(c) a poly(tert-butylacrylic) polymer as the polymer linked to the initiator moiety and optionally with a distal acrylic acid moiety in place of a tert-butylacrylate moiety.

2. The composite of claim 1 wherein the exposed surface of the substrate is selected from the group consisting of Au, Pt, Al, SiO₂, Si and organic polymers.

3. The composite of claims 1 or 2 wherein the linker moiety and the polymer together have a thickness between about 100 nm and 350 nm on the exposed surface of the substrate.

4. The composite of claims 1 or 2 wherein the linker moiety comprises (CH₂)ₙ wherein n is 2 to 20.

5. The composite of claims 1 or 2 wherein the linker moiety comprises (CH₂)ₙ wherein n is 11.

6. The composite of claim 1 wherein the substrate is a precious metal.

7. The composite of claims 1 or 2 wherein the linker moiety is comprised of sulfur which is linked to the exposed surface and the sulfur is linked to a (CH₂)ₙ moiety, wherein n is 2 to 20.

8. The composite of claims 1 or 2 wherein the linker moiety is comprised of sulfur which is linked to the substrate and the sulfur is linked to a (CH₂)ₙ moiety and wherein the initiator is a 2-halo propionyl halide moiety linked to a terminal of the (CH₂)ₙ moiety, where halo and halide are bromine or chlorine.

9. A process for the preparation of a composite which comprises:
(a) providing a substrate linked by a linker moiety on an exposed substrate linked to a halogenated initiator moiety;
(b) introducing a vinyl monomer with the linker moiety on the substrate along with a reduced transition metal linked to a ligand as a catalyst to provide a reaction mixture; and
(c) heating the reaction mixture to polymerize the vinyl monomer from the initiator with displacement of a halogen from the initiator to provide the polymer linked to the linker moiety which is linked to the substrate.

10. The process of claim 9 wherein a non-reactive solvent is provided in step (a).

11. The process of claims 9 or 10 wherein the exposed surface of the substrate is selected from the group consisting of Au, Pt, Al, SiO₂, Si and organic polymers.

12. The process of claims 9 or 10 wherein the linker moiety and the polymer together have a thickness between about 100 nm and 350 nm on the surface of the substrate.

13. The process of claims 9 or 10 wherein the linker moiety is comprised of sulfur linked to the exposed surface and the sulfur linked to (CH₂)ₙ linked to the initiator moiety, wherein n is 2 to 20.

14. The process of claims 9 or 10 wherein the linker moiety is comprised of sulfur linked to the surface and the sulfur is linked to (CH₂)₁₁ linked to the initiator moiety which is a 2-halo propionyl halide moiety linked to a terminal of the (CH₂)₁₁, where halo and halide are chlorine or bromine.

15. The process of claims 9 or 10 wherein the initiator moiety is comprised of a 2-bromo propionyl bromide moiety.

16. The process of claims 9 or 10 wherein the heating is at a temperature between about 25 and 55° C.

17. The process of claims 9 or 10 wherein the halogen is halogenated bromide.

18. The process of claims 9 or 10 wherein the vinyl monomer is tert-butylacrylate (tBA).

19. The process of claim 10 wherein the solvent is a mixture of dimethylformamide (DMF) and anisole.

20. The composite of claims 1 or 2 wherein in addition a terminal tert-butyl moiety of the acrylate has been hydrolyzed to the acrylic acid moiety.

21. The process of claim 20 wherein in addition a terminal tert-butyl moiety of the acrylate is hydrolyzed to the acrylic acid moiety.

22. The process of claims 9 to 10 wherein the vinyl monomer is selected from the group consisting of 4-vinyl pyridine, styrene methyl methacrylate, 2-hydroxyl ethyl methacrylate, and an alkyl acrylic monomer.

23. The composite produced by the process of claim 9 wherein the vinyl monomer is selected from the group consisting of 4-vinyl pyridine, styrene, and methyl methacrylate.
